(19) United States
(12) Patent Application Publication
(10) Pub. No.: US 2006/0125647 A1
(43) Pub. Date: Jun. 15, 2006

(54) Aquarium water-level detector

(75) Inventors: Gary Oakes, San Diego, CA (US); Ibrahim Hanna Makhlouf, Fullerton, CA (US); Rick Slemmer, San Diego, CA (US); Chris Ross, Del Mar, CA (US); David Picco, Carlsbad, CA (US); Jeffrey Ross Gray, San Diego, CA (US); Yuan-Ching Liu, San Diego, CA (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(73) Assignee: Touridan Inc.

(21) Appl. No.: 11/315,428

(22) Filed: Dec. 21, 2005

Related U.S. Application Data
(63) Continuation-in-part of application No. 11/115,658, filed on Apr. 27, 2005.
(63) Continuation-in-part of application No. 10/804,304, filed on Mar. 19, 2004.
(63) Continuation-in-part of application No. 11/186,216, filed on Jul. 21, 2005.
(60) Provisional application No. 60/639,048, filed on Dec. 22, 2004.

(51) Int. Cl. G08B 21/00

(52) U.S. Cl. 340/604; 340/605; 340/620

(57) ABSTRACT

An aquarium liquid security system is provided. The system includes an aquarium tank, i.e., a plurality of transparent material sheets joined at the sheet edges, and a liquid detection sensor. The sensor is at least partially wrapped around the perimeter, and is electrically responsive to liquid. An alarm interface is connected to the sensor. In one aspect, the sensor includes a pair of electrically conductive ink traces printed on the outside surfaces of the transparent material sheets. In another aspect, the sensor includes a liquid-permeable strip of material, a pair of electrically conductive traces, and a liquid-permeable adhesive attaching the sensor to the perimeter outside surface. Examples of liquid-permeable materials include cardboard, burlap, cotton cloth, synthetic cloth, paper, or cheesecloth. Alternately, the sensors can be formed on the interior surfaces of the aquarium and used for the detection of a low level of water.

### RELATED APPLICATIONS

This application claims the benefit of a provisional patent application entitled, LIQUID DETECTION SENSOR WITH LIQUID PERMEABLE INSULATOR, invented by Oakes et al., Ser. No. 60/639,048, filed Dec. 22, 2004.

This application is a continuation-in-part of a pending patent application entitled, VESSEL LIQUID OVERFLOW DETECTOR, invented by Picco et al., Ser. No. 11/115,658, filed Apr. 27, 2005.

This application is a continuation-in-part of a pending patent application entitled, SYSTEM AND METHOD FOR DETECTING WATER LEAKAGE, invented by Picco et al., Ser. No. 10/804,304, filed Mar. 19, 2004.

This application is a continuation-in-part of a pending patent application entitled, FLEXIBLE LEAK DETECTION SENSOR, invented by Picco et al., Ser. No. 11/186,216, filed Jul. 21, 2005.

All the above-mentioned applications are incorporated herein by reference.

### BACKGROUND OF THE INVENTION

1. Field of the Invention

This invention generally relates to liquid detection sensors and, more particularly, to a liquid detection device for low water levels in an aquarium or other liquid-bearing vessels.

2. Description of the Related Art

Plumbing failures in residential and commercial building result in millions of dollars of damage each year, in this country alone. As a result, systems have been designed to detect pools of water or leakage from a pipe. For example, conductive liquid sensors are known that consist of two electrically conductive materials formed on an insulating material in close proximity, but without touching. When liquid is sensed across the two conductive materials, the resistance between the conductive materials drops. This reduction in resistance is monitored, and a decrease in resistance can indicate the presence of liquid. This method provides an economical means to sense liquid on floor surfaces due to leaks in pipes, failed fittings, leaking valves, and floods.

Many sensors are essentially two-dimensional. They can be located over a wall or a floor, for example, to detect the presence of water. However, these sensors are not sufficiently subtle to detect a leak in all conditions, or on all surfaces. Likewise, a two-dimensional sensor may not be able to detect a fine leak in an aquarium, or a larger leak that happens to drain in a direction away from the sensor location.

The maintenance of the proper water level is a significant problem associated with the care of aquariums. A drop in water level may be the result of a leak, but more likely is the result of a pet owner forgetting to fill the tank. Low water levels are unhealthy for fish, and may also be harmful for operating pump and filter equipment.

It would be advantageous if a liquid detection sensor could be made to cooperate with an aquarium, to detect low water levels and water leaks.

### SUMMARY OF THE INVENTION

Accordingly, an aquarium water-level and leak detection system is provided. The system comprises an aquarium tank, i.e., a plurality of transparent material sheets joined at the sheet edges, and a liquid detection sensor. The sensor is at least partially wrapped around the perimeter outside surface, and is electrically responsive to liquid. An alarm interface is connected to the sensor. In one aspect, the sensor includes a pair of electrically conductive ink traces printed on the outside surfaces of the transparent material sheets. In another aspect, the sensor includes a liquid-permeable strip of material, a pair of electrically conductive traces, and a liquid-permeable adhesive attaching the sensor to the perimeter outside surface. Examples of liquid-permeable materials include cardboard, burlap, cotton cloth, synthetic cloth, paper, or cheesecloth.

The aquarium leak security system may also include an alarm unit having a sensor interface connected to the sensor's alarm interface. The alarm creates an alarm signal in response to measuring a predetermined sensor resistance. If the sensors are formed on the exterior surface of the aquarium and used for the detection of a water leak, then the alarm is triggered in response to a minimum resistance threshold. That is, the sensor gets wet, the sensor resistance decreases, and alarm is triggered as a result of the change in resistance. Alternately, if the sensors are formed on the interior surfaces of the aquarium and used for the detection of a low level of water, then the alarm is triggered in response to a maximum threshold. In some aspects, the resistance threshold can be adjusted. This feature is of value when different types of liquid are used. For example, different thresholds might be used for freshwater and saltwater aquariums.

Additional details of the above-described aquarium liquid security system are provided below.

### BRIEF DESCRIPTION OF THE DRAWINGS

FIG. 1 is a partial cross-sectional view of a liquid detector with a liquid-permeable insulator.

FIGS. 2a and 2b depict partial cross-sectional views of a variation of the detector of FIG. 1.

FIG. 3 depicts a partial cross-sectional view of a one-sided insulator variation of the detector of FIG. 1.

FIG. 4 depicts a partial cross-sectional view of a detector with liquid permeable sides.

FIG. 5 is a partial cross-sectional view of a multi-surface three-dimensional liquid detector.

FIGS. 6A, 6B, and 6C are partial cross-sectional and plan views of an aquarium liquid security system.

FIGS. 7A and 7B depict different cross-sectional views of a variation of the aquarium leak security system.

FIGS. 8A through 8F depict cross-sectional views of an aquarium water-level detector system.

FIG. 9A is a partial cross-sectional view of a variation of the water-level detection system of FIG. 8A.

FIGS. 9B and 9C are variations of the pressure-sensitive sensor shown in FIG. 9A.

FIGS. 10A through 10F are partial cross-sectional views of transparent sensors that may be used for water-level detection or leak detection.

### DETAILED DESCRIPTION

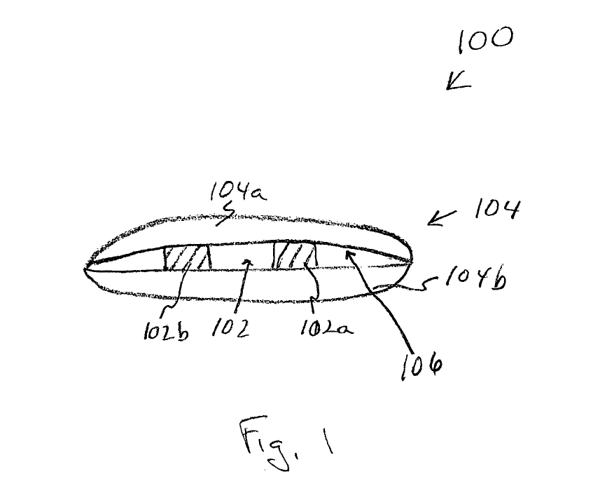

FIG. 1 is a partial cross-sectional view of a liquid detector with a liquid-permeable insulator. The detector 100 comprises a sensor 102 electrically responsive to proximate liquid, and a liquid-permeable insulator 104 at least partially enveloping the sensor 102. As shown, the liquid-permeable insulator 104 includes a first strip of material 104a and second strip of material 104b overlying the first strip 104a. The sensor 102 may be a pair of electrically conductive traces 102a and 102b (shown as cross-hatched), interposed between the first strip of material 104a and the second strip of material 104b.

In one aspect, the sensor traces 102a and 102b are conductive ink printed on an interior surface 106 of the first strip of material 104b. Suitable conductive inks are manufactured by T-Ink, Seiko Epson, and E Ink, to name a few manufacturers. Alternately, the sensor traces are metallic wires attached to an interior surface 106 of the first strip of material 104a. Although not specifically shown, the conductive traces may be formed in particular patterns, for example, a serpentine pattern. Further, the traces may include attached barbs or pins, which may, or may not extend through the insulator material, to form a 3D liquid detection field.

Typically, the detector 100 is connected to a controller, which is not shown in this figure. The controller may create a voltage differential between traces 102a and 102b. The controller detects changes in the voltage differential, resistance, or capacitance between the two traces to determine the presence of a liquid, such as water. For example, the presence of water between traces 102a and 102b may result in decreased electrical resistance. The controller may measure changes in electrical resistance and generate an alarm signal in response. The alarm signal may be used to alert a user, or trigger another electrical circuit. For example, the alarm signal may be used to shut an electronically controlled water valve. In other aspects not shown, the traces 102a and 102b may be formed on a sheet of dielectric. Changes to the electrical characteristics of the dielectric sheet in the presence of a liquid may contribute to the electrical measurement.

In one variation, both the first strip 104a and second strip 104b are a liquid-permeable material, such as cardboard, burlap, cotton cloth, synthetic cloth, paper, or cheesecloth. This is not an exhaustive list of every possible type of liquid-permeable material that can be used. Alternately, the detector 100 may include a liquid-impermeable insulator at least partially enveloping the sensor. For example, strip 104a may be liquid-permeable, while strip 104b may be liquid-impermeable.

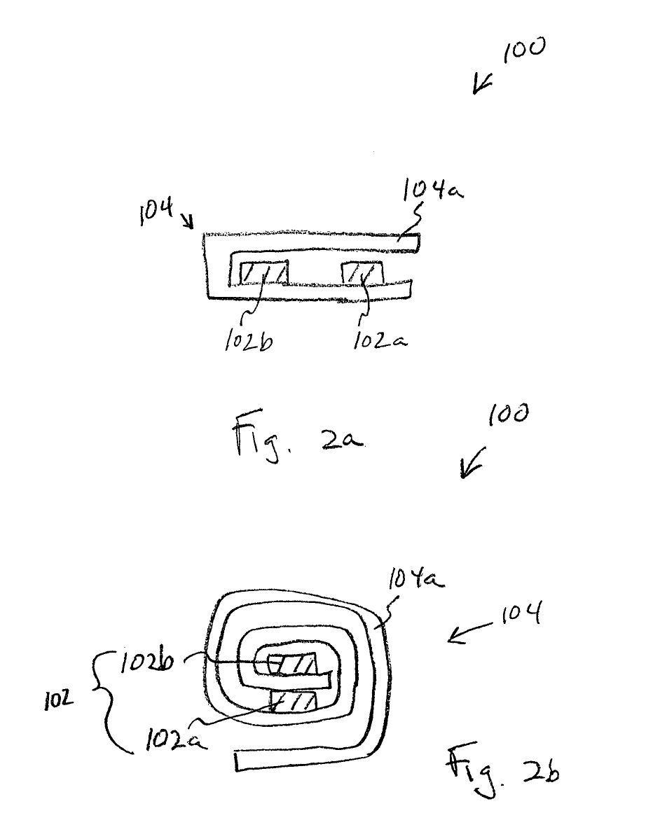

FIGS. 2a and 2b depict partial cross-sectional views of a variation of the detector of FIG. 1. The liquid-permeable insulator 104 includes a first strip of material 104a. The sensor 102 includes a pair of electrically conductive traces 102a and 102b formed on the first strip of material 104a. The first strip of material 104a is formed to shelter the conductive traces 102a and 102b. In FIG. 2a, the shelter is formed by folding the insulator 104a. In FIG. 2b the shelter is formed by rolling the insulator 104a. Other arrangements of sheltering the conductive traces in a single sheet of insulator are also possible.

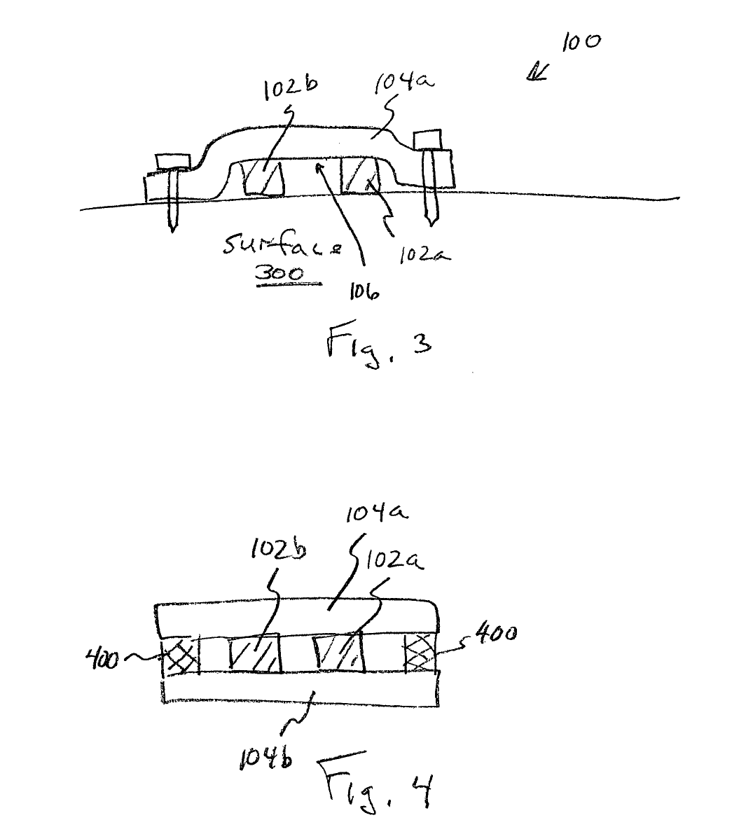

FIG. 3 depicts a partial cross-sectional view of a one-sided insulator variation of the detector of FIG. 1. In this variation the traces 102a and 102b are formed on a single sheet of insulator 104a, on surface 106. The surface 106 (and conductive traces 102a/102b) are turned to a mating surface 300. For example, the surface 300 can be dry wall. The traces 102a and 102b are sheltered by attaching the insulator strip 104a to the surface 300. Note, is this variation the insulator may be liquid-permeable or liquid-impermeable.

FIG. 4 depicts a partial cross-sectional view of a detector with liquid permeable sides. In this variation, insulator 104a and 104b are liquid-impermeable, and joined by liquid-permeable sides 400. Alternately, strips 104a and 104b are liquid-permeable, but the sides 400 are not. In another variation, strips 104a and 104b, as well as sides 400, are liquid-permeable.

FIG. 5 is a partial cross-sectional view of a multi-surface three-dimensional liquid detector. The detector 500 comprises a carpet three-dimensional (3D) liquid detection field 502 extending a first length 504 into a first plane 506. The detector 500 also comprises a hard-floor 3D liquid detection field 508 extending a second length 510 into a second plane 512. A sensor 514 supplies an electrical resistance responsive to liquid in the detection fields 502 and 508. As shown, the sensor 504 includes two traces 504a and 504b. In some aspects as shown, the carpet and hard-floor sensors are connected in parallel, so that a single sensor detects liquid in either field 502 or 508. Alternately but not shown, there are two independent sensors, one for the carpet field and one for the hard-floor field.

In another aspect, the carpet 3D liquid detection field 502 includes a plurality of pins 520 having distal ends 522 electrically connected to the sensor 504, and having the first length 504. Likewise, the hard-floor 3D liquid detection field 508 includes a plurality of pins 524 having distal ends 526 electrically connected to the sensor 504, and having the second length 510. Typically, the first length 504 is greater than the second length 510. Alternately, the lengths are the same, or the second length 510 is greater than first length 504.

An alarm 530 is shown connected to the sensor 504, to supply an alarm signal 532 in response to resistance measurements. As discussed above, the alarm signal can take a variety of forms. Further, the alarm 530 may be connected to the sensor 504 to measure changes in voltage differential or capacitance. An electrical interface 534 is connected to the sensor 504 (and alarm 530) to supply an electrical resistance.

The detector 500 has a chassis 540 having a first surface 542 and a second surface 544. The carpet 3D detection field 502 extends from the chassis first surface 542. The hard-floor 3D detection field 508 extends from the chassis second surface 544.

It should be understood that detector 500 provides the user with at least two different sets of installation options. The detector 500 permits the measurement of liquid into two different types of fields. For example, a low profile field can be measured with the hard-floor field 508, while a deeper field can be measured using the carpet field 502. Although the fields have been identified as “hard-floor” and “carpet”, their use is not necessarily so restricted. For example, the fields may be used to measure liquid in a sheet of dry wall, or a layer of insulation. In another aspect, the detector gives the user to option of using either a relatively wide, low-profile installation, or a thin, high-profile installation. For example, the chassis first side 542 can turned to the ground if the detector is to be used under a carpet. Alternately, the second side 544 can be turned to the ground if the detector is to be used in a narrow space behind a refrigerator.

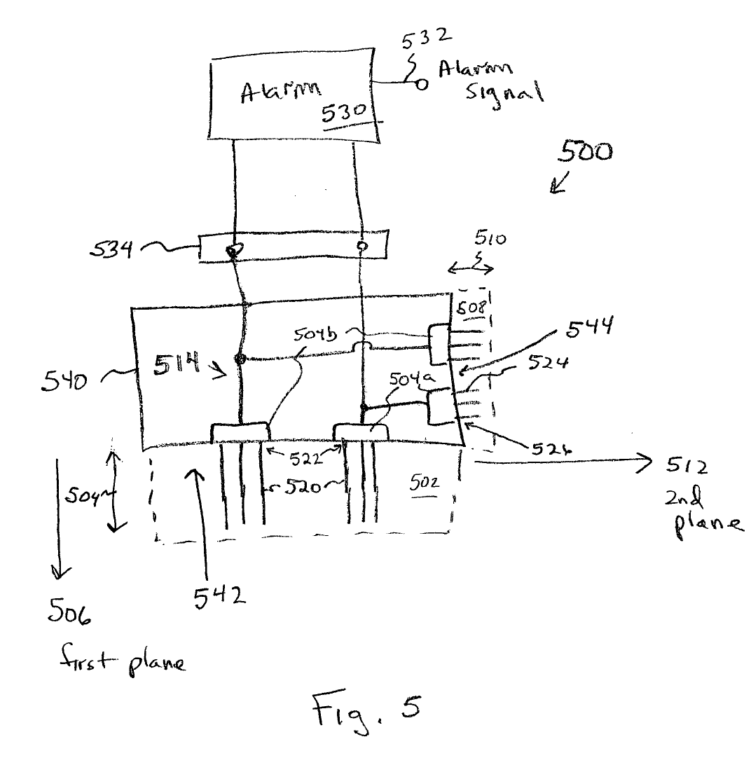

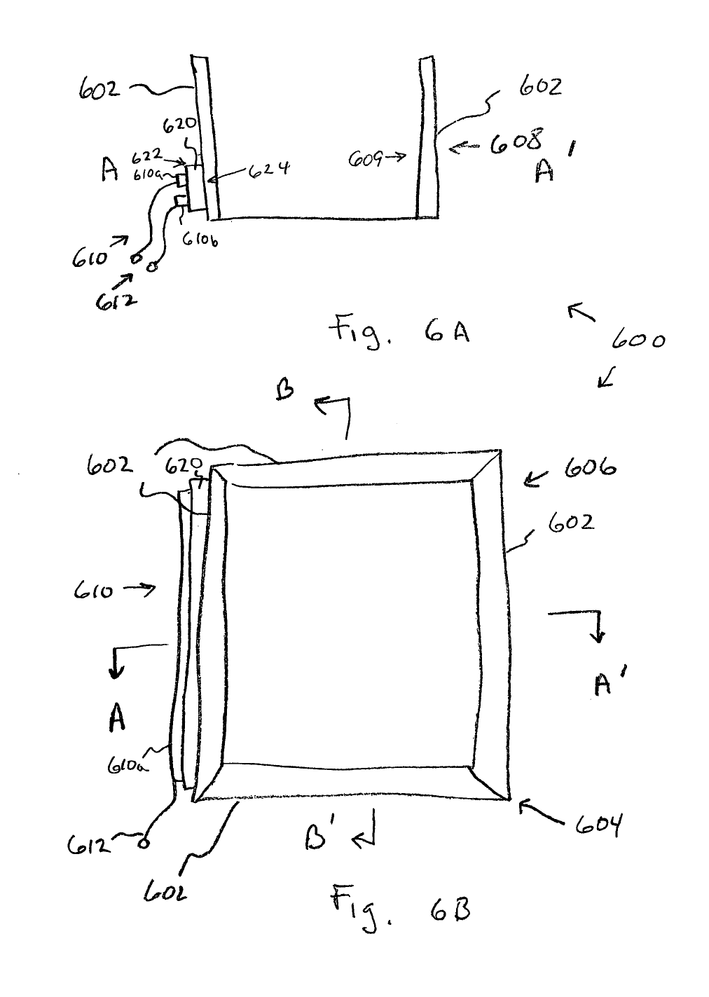

FIGS. 6A, 6B, and 6C are partial cross-sectional and plan views of an aquarium liquid security system. The system 600 comprises a plurality of transparent material sheets 602 joined at the sheet edges 604, forming an aquarium enclosure 606. An aquarium enclosure 606 has an outside surface 608 and an inside surface 609. Alternately, the aquarium enclosure 606 may be of a one-piece or molded construction. A liquid detection sensor 610 is attachable to the enclosure outside surface 608. For simplicity, the sensor 610 is shown as mounted on only a single sheet 602. However, it should be understood that the sensor 610 can be formed on more than one transparent sheet, or that the aquarium may formed with a sensor on each transparent sheet. The sensor 610 is electrically responsive to liquid. An alarm interface 612 is connected to the sensor 610.

The sensor 610 may be formed from a pair of electrically conductive ink traces 610a and 610b printed on the outside surfaces 608 of the transparent material sheets 602. In another aspect, the traces are regions of the sheet 602, doped with an electrically conductant or metal dopant to name a few examples, to make the doped regions electrically conductive. Alternately, the electrically conductive traces 610a and 610b may be a metallic material or conductive oxide material formed overlying the sheet 602.

In one aspect, the sensor 610 includes a liquid-permeable strip of material 620 with a first side 622 and a second side 624. The pair of electrically conductive traces 610a and 610b is formed on the strip first side 622. A liquid-permeable adhesive is formed on the strip second side 624, attaching the sensor 610 to the perimeter outside surface 608. Alternately but not shown, the adhesive is not liquid-permeable, but the adhesive is applied so that channels are formed to permit liquid to penetrate into the strip 620.

If the aquarium overflows, or a leak develops along one of the sheet edges 604, the sensor 610 will detect water on the outside surface of the aquarium 608. The sensor interface 612 can be connected to an alarm or controller 630 (see FIG. 6C). In another aspect not specifically shown, the electrically conductive traces 610a and 610b are embedded in the liquid-permeable strip 620. For example, the sensor shown in FIG. 4 can be attached to a transparent sheet 602.

The alarm unit 630 (FIG. 6C) has a sensor interface 632 connected to the sensor's alarm interface, for creating an alarm signal in response to measuring a predetermined sensor resistance. For example, the alarm signal can be an audible alarm or a blinking light. In one aspect, the alarm unit 630 has an output interface 634 for sending an auxiliary alarm signal in response to measuring the predetermined sensor resistance. For example, the auxiliary alarm may be connected to an automatic telephone system (not shown) that sends a voice message in response to an alarm signal. Alternately, the auxiliary alarm may signal a home security system (not shown). In another aspect, the auxiliary signal may trigger an aquarium exhaust port (not shown) that automatically drains the aquarium.

In another aspect, the alarm unit 630 has a user interface (UI) 636 for selecting the predetermined resistance threshold. For example, if children are known to play in the aquarium, it may be useful to set the minimum resistance alarm threshold to a higher setting, to prevent minor spills from acting as a trigger. As another example, if sensors are mounted to a vessel that bears a liquid other than water, with a conductivity different than water, the user may choose to select a threshold appropriate for that liquid. As a final example, a user may choose a different threshold setting for a freshwater aquarium, than they would for a saltwater aquarium.

FIGS. 6A through 6C show a leak-detection variation of the liquid security system 600, with sensors mounted on the outside surfaces of the aquarium enclosure. Alternately (see FIGS. 8A through 8F), these same sensors can be mounted on the interior surfaces of the aquarium enclosure to form a water-level detection system. In this aspect, the alarm would be set to trigger at a maximum resistance threshold, as the resistance between the electrically conductive traces of the sensor increases in the absence of liquid. As explained above for the leak-detection system, the alarm UI 636 may be adjusted for different types of liquids, freshwater, or saltwater.

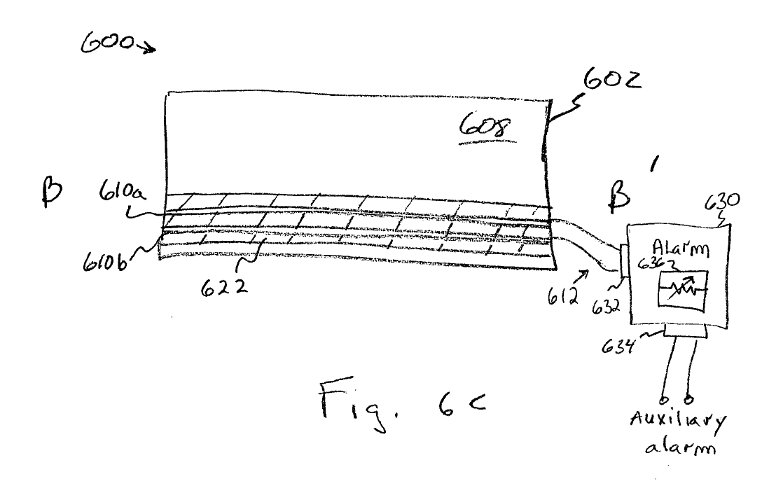

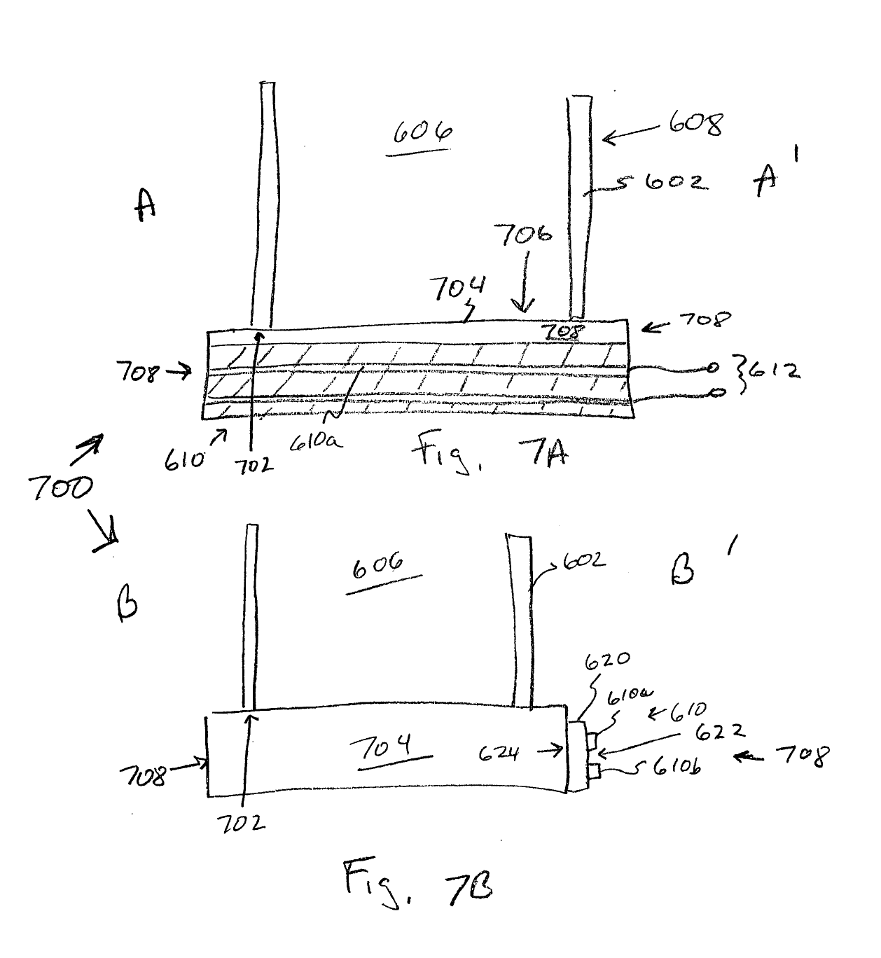

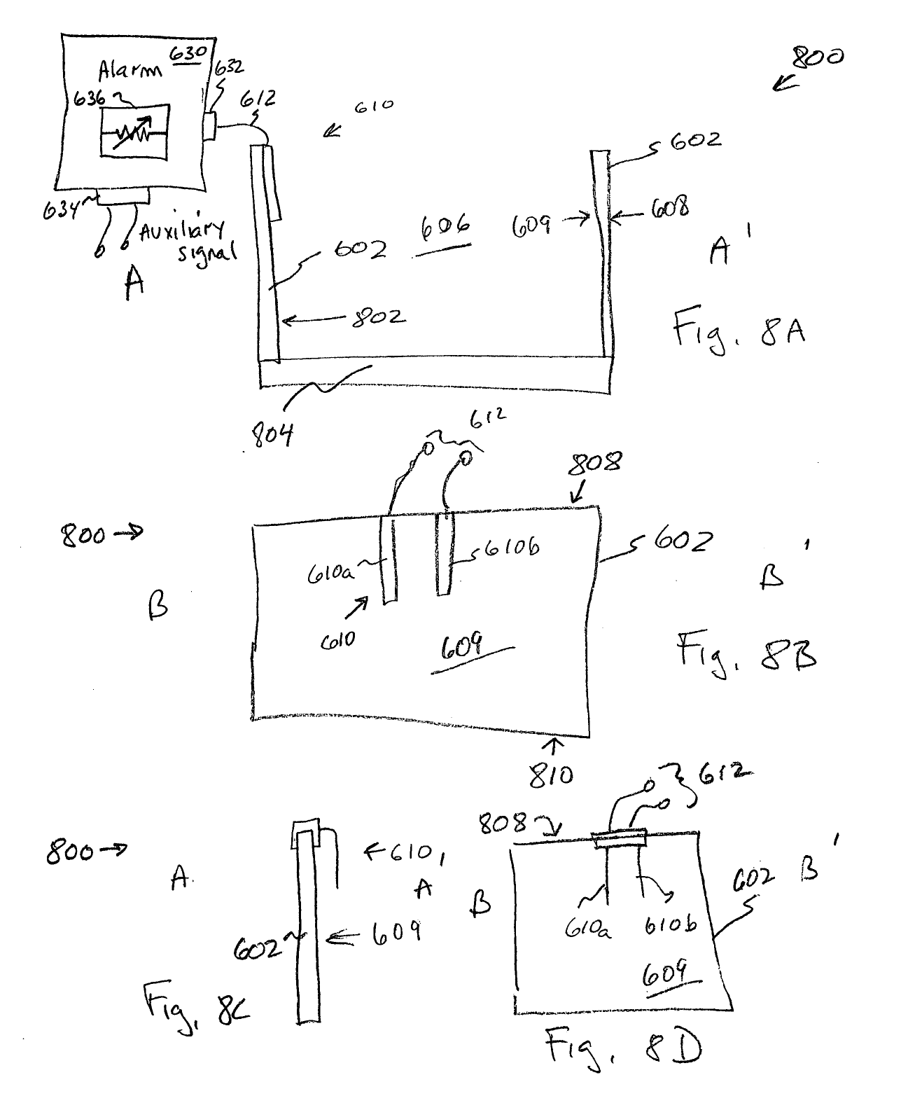

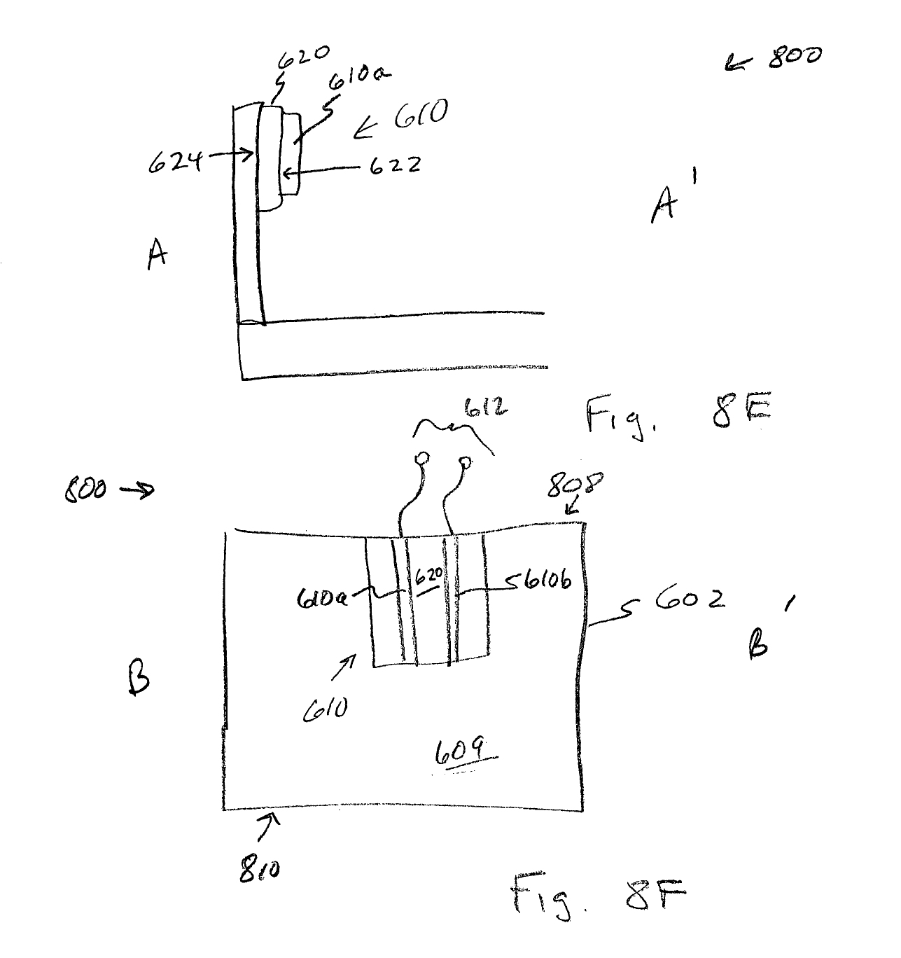

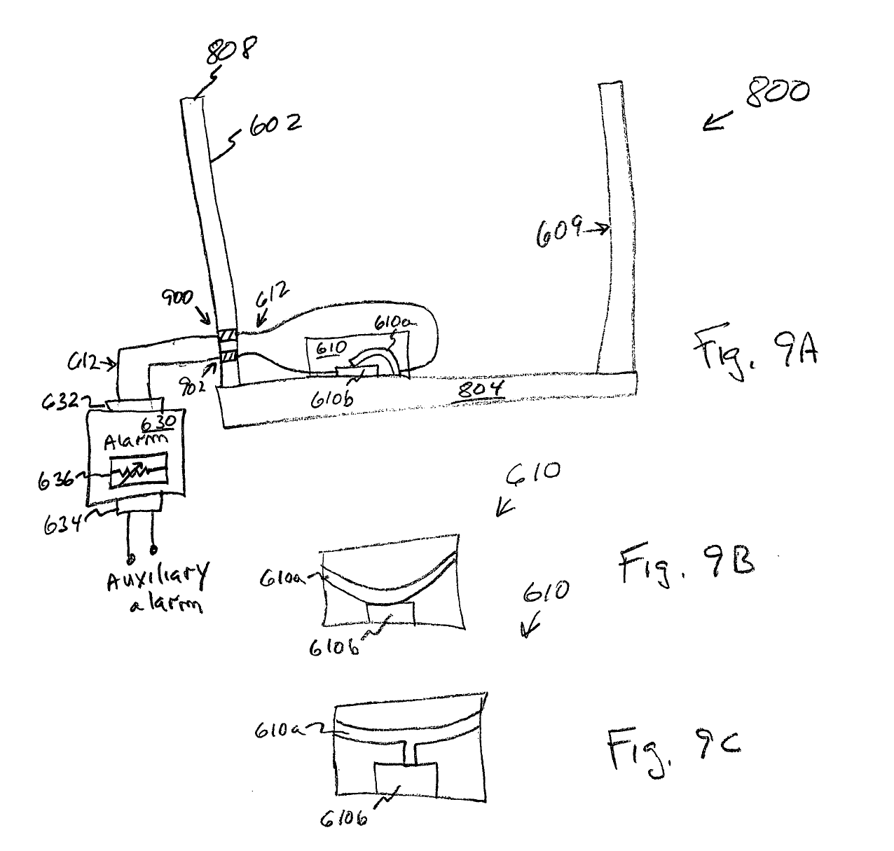

FIGS. 7A and 7B depict different cross-sectional views of a variation of the aquarium leak security system. As above, the system 700 comprises a plurality of transparent material sheets 602 joined at the sheet edges, forming an aquarium enclosure 606 with an outside surface 608 and a bottom 702. The sheet edges cannot be seen in the cross-section. An aquarium base 704 has a top face 706 attached to the perimeter bottom 702. The base 704 also has sides 708. A liquid detection sensor 610 is at least partially wrapped around the sides 708 of the base 704, electrically responsive to liquid. The system 700 has an alarm interface 612 connected to the sensor 610.

For example, the sensor 610 may include a pair of electrically conductive ink traces 610a and 610b printed on the sides 708 of the base 704. In another aspect, the traces are regions of a base side(s) 708, doped with an electrically conductive or metal dopant to name a few examples, making the doped regions electrically conductive. Alternately, the electrically conductive traces 610a and 610b may be a metallic material or conductive oxide material formed overlying the base side 708.

As shown, the sensor 610 includes a liquid-permeable strip 620 of material with a first side 622 and a second side 624. A pair electrically conductive traces 610a and 610b is formed on the strip first side 622. A liquid-permeable adhesive is formed on the strip second side 624, attaching the sensor 610 to the sides 708 of the base 704. Alternately but not shown, the adhesive is not liquid-permeable, but the adhesive is applied so that channels are formed to permit liquid to penetrate into the strip 620.

FIGS. 8A through 8F depict cross-sectional views of an aquarium water-level detector system. The system 800 comprises a plurality of transparent material sheets 602 joined at the sheet edges, forming an aquarium enclosure 606 with an inside surface 608 and a bottom 804. The sheet edges are not visible in the cross-sections. A liquid detection sensor 610 is attachable to an aquarium enclosure inside surface 609 or outside surface 608, and is electrically responsive to the absence of water. An alarm interface 612 is connected to the sensor 610.

In one aspect (FIG. 8B), the sensor 610 includes a pair of electrically conductive ink traces 610a and 610b printed on the inside surface 609 of one of the transparent sheets 602. In another aspect, the traces are regions of the sheet 602, doped with an electrically conductive or metal dopant to name a few examples, to make the doped regions electrically conductive. Alternately, the electrically conductive traces 610a and 610b may be a metallic material or conductive oxide material formed overlying the sheet 602. The traces 610a and 610b extend from a top edge 808 of the transparent sheet towards a bottom edge 810. The alarm interface 612 is connected to the sensor 610 at the transparent sheet top edge 808.

Alternately (see FIGS. 8C and 8D), the sensor 610 includes a pair of conductive probes 610a and 610b attached to the top edge 808 of a transparent sheet 602, extending into the enclosure 606. The alarm interface 612 is connected to the sensor 610 at the transparent sheet top edge 808. The conductive probes may be connected to the enclosure using an adhesive, or clip, or other conventional joining means.

In another aspect, see FIGS. 8E and 8F, the sensor 610 includes a strip of material 620 with a first side 622 and a second side 624. A pair of electrically conductive traces 610a and 610b, made from a metal or conductive oxide for example, is formed on the strip first side 622. An adhesive is formed on the strip second side 624, attaching the sensor 610 to an inside surface 609 of one of the transparent sheets 602, extending from the top edge 808 towards the bottom edge 810. The alarm interface 612 is connected to the sensor at the transparent sheet top edge 808.

Referring again to FIG. 8A, an alarm unit 630 has a sensor interface 632 connected to the sensor's alarm interface 612, for creating an alarm signal in response to measuring a maximum sensor resistance. The sensor resistance increases in the absence of liquid. In one aspect, the alarm unit 630 has an output interface 634 for sending an auxiliary alarm signal in response to measuring the maximum sensor resistance. For example, the auxiliary alarm may be hooked into the home security system (not shown), or may open an electronically controlled value (not shown) that introduces additional water into the aquarium. In another aspect, the alarm unit 630 has a user interface 636 for selecting the maximum resistance threshold.

FIG. 9A is a partial cross-sectional view of a variation of the water-level detection system 800 of FIG. 8A. In this variation, the liquid detection sensor 610 is mounted on an aquarium enclosure inside surface. As shown, the sensor 610 is mounted on the aquarium bottom 804. Alternately but not shown, the sensor can be mounted to a transparent sheet inside surface 609. The sensor 610 includes a pair of tensioned electrical conductors (610a and 610b) responsive to water pressure.

FIGS. 9B and 9C are variations of the pressure-sensitive sensor 610 shown in FIG. 9A. Note, there are a variety pressure sensors well known in the art that could be adapted for use with the water-level detection system 800 depicted in FIG. 9A. One, or both of the traces 610a/610b may be tensioned to be responsive to water pressure. Alternately, a pressure sensitive element may act to separate the traces 610a/610b. The sensors 610 shown in FIGS. 9A through 9C imply a “make or break” type of connection. In some aspects however, the resistance between traces increases as the pressure on the top trace decreases, and the surface area connecting the top trace 610a with the bottom trace 610b changes without the contact being broken.

The leads (interface 612) connected to the sensor 610 (FIG. 9A) are shown passing through conductive electrodes 900 and 902 in the transparent sheet 602. For example, the electrodes can be a metal. In one aspect, the electrodes 900/902 are formed by doping selected regions of the sheet 602 with a conductant material. Alternately but not shown, holes can be drilled in the transparent sheet 602, the leads 612 passed through the holes, and the holes filled with a sealant. In a different aspect not shown, electrodes or holes can be formed through bottom 804. Alternately but not shown, the leads 612 can run over the top edge 808 of the sheet 602.

An alarm unit 630 may have a sensor interface 632 connected to the sensor's alarm interface 612, for creating an alarm signal in response to measuring a maximum sensor resistance. The alarm 630 may optionally have a user interface 636 for selecting the maximum resistance threshold, or an interface 634 for an auxiliary alarm.

Although not specifically shown, the above-mentioned water pressure sensor 610 may be enclosed in a decorative housing such as treasure chest, sunken ship, deep-sea diver, coral reef, or the like. Further, the sensor may be combined with non-ornamental objects conventionally found in an aquarium, such as a salinity gauge, fish food dispenser, gravel pad, or air bubbler.

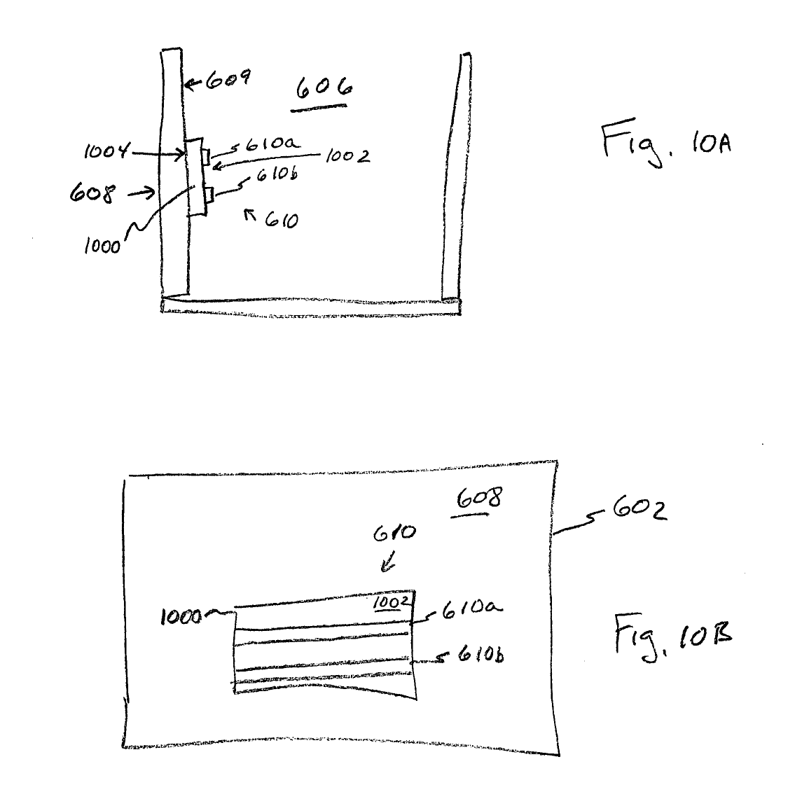

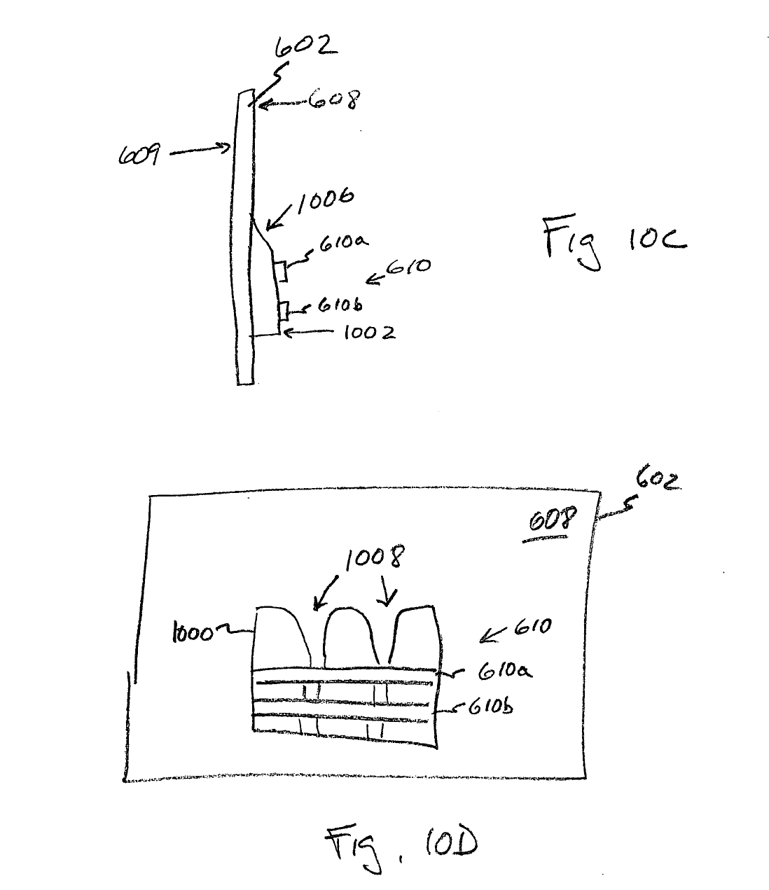

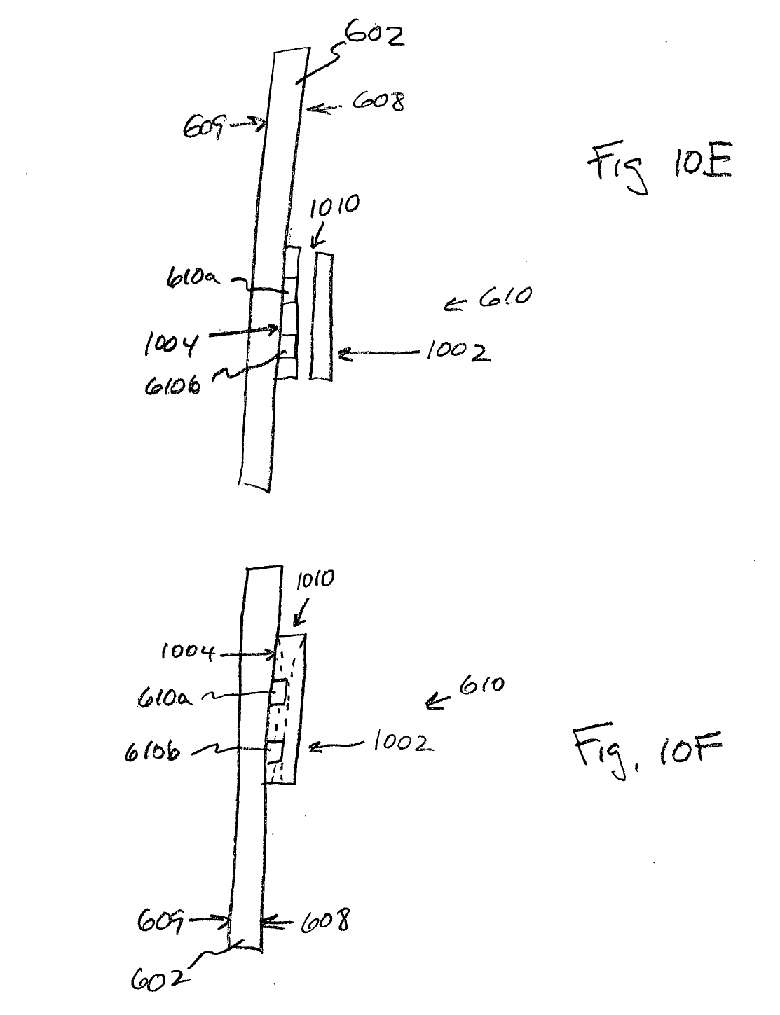

FIGS. 10A through 10F are partial cross-sectional views of transparent sensors that may be used for water-level detection or leak detection. In FIG. 10A, sensor 610 includes a transparent dielectric sheet 1000, which may be a material such a glass, quartz, or plastic. The transparent sheet 1000 has a top surface 1002 and a bottom surface 1004. Electrically conductive traces 610a and 610b are formed on the top surface 1002. As shown, the sensor 610 is mounted to an interior surface 609 of aquarium enclosure 606. The sensor 610 can be used to detect a low level of water in the enclosure 606. Advantageously, the transparent sensor does not block light, and permits an unrestricted view into the aquarium enclosure 606. In other aspects not shown, the transparent sheet forms a lens to magnify images seen through the sheet.

In FIGS. 10B through 10D, the transparent sensor 610 is mounted to an aquarium outside surface 608. As shown, the transparent dielectric sheet 1000 has a sloped top edge 1006, so that any water leaking down the outside surface 608 is encouraged to run over the electrically conductive traces 610a and 610b on the top surface 1002, as opposed to bypassing the sensor top surface 1002.

In FIG. 10D, channels 1008 are formed in the transparent dielectric top surface to more effectively control and direct the flow of any leaking water across electrically conductive traces 610a and 610b.

To prevent a user from accidentally breaking the electrical continuity of one of the traces 610a or 610b, the traces can be mounted on the bottom surface 1004 of the transparent dielectric 1000, as shown in FIGS. 10E and 10F. Channels 1010 are used to direct any water flowing down the aquarium outside surface 608, to pass across exposed sections of the traces 610a and 610b. In another aspect not shown, the sensors are embedded in the transparent dielectric sheet 1000, and accessed through channels 1010. Although not specifically shown, the sensor of FIG. 10E can also be mounted to an aquarium interior surface to detect (low) water-level readings.

In one aspect, the electrically conductive traces 610a/610b in FIGS. 10A through 10F can be a conductive ink or metallic material. In another aspect, the traces can be made transparent by using a very thin layer of metal, such as gold. Alternately, the traces can be regions of the transparent dielectric sheet 1000 that are doped with an electrically conductive or metal dopant to name a few examples, to make the doped regions electrically conductive. Alternately, the electrically conductive traces 610a and 610b may be a metallic material or conductive oxide material formed overlying the sheet 602. In one variation, a transparent metal oxide such as indium tin oxide (ITO) can be used to form the traces.

Examples of aquarium alarm systems, insulated liquid-permeable sensors, and multi-surface sensors have been provided to illustrate the invention. The invention is applicable to other liquid-bearing vessels other than an aquarium, and is not limited to merely these examples. Other variations and embodiments of the invention will occur to those skilled in the art.

We claim:

1. An aquarium liquid security system, the system comprising:
a liquid detection sensor, attachable to an aquarium enclosure, electrically responsive to liquid; and,
an alarm interface connected to the sensor.

2. The aquarium leak security system of claim 1 wherein the sensor includes a pair of electrically conductive ink traces printed on an aquarium enclosure.

3. The aquarium leak security system of claim 1 wherein the sensor includes:
a liquid-permeable strip of material with a first external surface;
a pair of electrically conductive traces; and,
liquid-permeable adhesive formed on the strip first surface, for attaching the sensor to an aquarium enclosure.

4. The aquarium leak security system of claim 3 wherein the pair of electrically conductive traces are embedded in the strip.

5. The aquarium leak security system of claim 1 wherein the sensor includes:
a transparent dielectric sheet with a surface, attachable to an aquarium enclosure; and,
a pair of electrically conductive traces formed on the transparent dielectric sheet surface.

6. The aquarium leak security system of claim 1 further comprising:
an alarm unit having a sensor interface connected to the sensor's alarm interface, for creating an alarm signal in response to measuring a predetermined sensor resistance.

7. The aquarium leak security system of claim 6 wherein the alarm unit has an output interface for sending an auxiliary alarm signal in response to measuring the predetermined sensor resistance.

8. The aquarium leak security system of claim 6 wherein the alarm unit has a user interface for selecting the predetermined resistance threshold.

9. An aquarium leak security system, the system comprising:
an aquarium base having a top face attachable to an aquarium enclosure bottom surface, and having sides;
a liquid detection sensor, at least partially wrapped around the sides of the base, electrically responsive to liquid; and,
an alarm interface connected to the sensor.

10. The aquarium leak security system of claim 9 wherein the sensor includes a pair of electrically conductive ink traces printed on the sides of the base.

11. The aquarium leak security system of claim 9 wherein the sensor includes:
a liquid-permeable strip of material with a first external surface;
a pair electrically conductive traces; and,
liquid-permeable adhesive formed on the strip first surface, attaching the sensor to the sides of the base.

12. An aquarium water-level detector system, the system comprising:
a liquid detection sensor, attachable to an aquarium enclosure inside surface, electrically responsive to the absence of water; and,
an alarm interface connected to the sensor.

13. The water-level detection system of claim 12 wherein the sensor includes a pair of conductive ink traces printed on the inside surface of an aquarium enclosure, extending from a top edge of the enclosure towards a bottom edge; and,
wherein the alarm interface is connected to the sensor at the enclosure top edge.

14. The water-level detection system of claim 12 wherein the sensor includes a pair of electrically conductive probes attachable to a top edge of an aquarium enclosure, extendable into the enclosure; and
wherein the alarm interface is connected to the sensor at the aquarium enclosure top edge.

15. The water-level detection system of claim 12 wherein the sensor includes:
a strip of material with a first surface and a second surface;
a pair of electrically conductive traces formed on the strip first surface;
adhesive formed on the strip second surface, for attaching the sensor to an inside surface of an aquarium enclosure, extending from a top edge of the enclosure towards a bottom edge; and,
wherein the alarm interface is connected to the sensor at the enclosure top edge.

16. The water-level detection system of claim 12 further comprising:
an alarm unit having a sensor interface connected to the sensor's alarm interface, for creating an alarm signal in response to measuring a maximum sensor resistance.

17. The water-level detection system of claim 16 wherein the alarm unit has an output for sending an auxiliary alarm signal in response to measuring the maximum sensor resistance.

18. The water-level detection system of claim 16 wherein the alarm unit has a user interface for selecting the maximum resistance threshold.

19. The water-level detection system of claim 12 wherein the liquid detection sensor includes a pair of tensioned electrical conductors responsive to water pressure, for mounting on an aquarium enclosure inside surface.

20. The water-level detection system of claim 12 wherein the sensor includes:
a transparent dielectric sheet with a surface, attachable to an aquarium enclosure inside surface; and,
a pair of electrically conductive traces formed on the transparent dielectric sheet surface.
